(19) United States
(12) Patent Application Publication
(10) Pub. No.: US 2009/0184434 A1
(43) Pub. Date: Jul. 23, 2009

(54) VARIABLE VENTURI CARBURETOR

(75) Inventors: Toshimasa Takahashi, Shiroishi-City (JP); Tamio Aihara, Shibata-Gun (JP); Jun Takano, Shibata-Gun (JP); Dairoku Suzuki, Kakuda-City (JP); Takeshi Sakaguchi, Natori-City (JP)

Correspondence Address: REISING, ETHINGTON, BARNES, KISSELLE, P.C., P O BOX 4390, TROY, MI, 48099-4390, US

(73) Assignee: Walbro Engine Management, L.L.C., Tucson, AZ (US)

(21) Appl. No.: 12/119,014

(22) Filed: May 12, 2008

(30) Foreign Application Priority Data
Jan. 21, 2008 (JP) 2008-010632

(51) Int. Cl. F02M 9/02; F02M 9/04; C10J 1/04

(52) U.S. Cl. 261/44.4; 261/50.1; 261/51

(57) ABSTRACT

A carburetor includes a main body defining a bore, a main passage and a venturi defined within the bore, and a fuel nozzle carried by the main body and including a fuel nozzle outlet communicating with the venturi. The carburetor may also include a valve member translatable across an axis of the bore, such that in a closed state, the valve member closes the main passage but maintains the venturi at least partially open. The carburetor may also include a needle valve disposed at an end of the fuel nozzle substantially opposite of the fuel nozzle outlet to variably control flow of fuel into a fuel nozzle inlet, and a needle valve transmission may be coupled between a throttle shaft and the needle valve to convert rotation of the throttle shaft to translation of the needle valve.

### CROSS-REFERENCE TO RELATED APPLICATION

Applicants claim priority of Japanese Application, Ser. No. 2008-010632, filed Jan. 21, 2008, which is incorporated herein by reference in its entirety.

### FIELD OF THE INVENTION

The present disclosure relates generally to carburetors for combustion engines, and more particularly to a variable venturi carburetor.

### BACKGROUND OF THE INVENTION

Conventionally, there has been a demand to improve carburetors for cleaner exhaust gas, and various structures therefor have been proposed. Some carburetors comprise a sliding throttle valve in which a valve member is translatable to increase and decrease an open area of a fuel and air mixing passage. See, for example, Japanese Utility Model Application No. 51-94686 (Utility Model Application Publication No. 53-012924). It is disclosed in the above publication that in a lower-speed or small opening operation mode of a sliding throttle valve carburetor with a variable venturi, a negative intake pressure at the venturi tends to be larger compared with a butterfly valve carburetor. Such large pressure can make an air fuel mixture ratio overly rich and thereby cause unfavorable performance, unless a needle jet is used to restrict supply of fuel to the venturi.

To address this problem, the above publication proposes use of two separate main jets; one dedicated to the lower-speed mode, and another dedicated to a higher-speed or large opening operation mode. However, in the above publication a needle member is repeatedly moved into and out of a fuel nozzle jet, and abrasion may occur between the needle member and the jet after an extended period of use. Such abrasion can deteriorate the performance of the carburetor compared with its initial performance, and deterioration of fuel consumption efficiency and exhaust performances can be particularly significant in the lower-speed mode.

### SUMMARY OF THE INVENTION

A carburetor according to one implementation includes a main body defining a bore extending through the main body along an axis, a main passage and a venturi defined within the bore, and a fuel nozzle carried by the main body and including a fuel nozzle outlet in fluid communication with the venturi. The carburetor also includes a valve member translatable with respect to the axis of the bore of the main body to control an open area of the bore, such that in a closed state, the valve member closes the main passage but maintains the venturi at least partially open to allow an amount of air for engine idling to flow therethrough.

According to another implementation, a carburetor includes a main body defining a bore extending through the main body along an axis, a main passage and a venturi defined within the bore, and a throttle shaft carried by the main body. The carburetor also includes a fuel bowl carried by the main body and defining a fuel reservoir, a fuel nozzle carried by the main body and including a fuel nozzle inlet in fluid communication with the fuel reservoir and a fuel nozzle outlet in fluid communication with the venturi. The carburetor further includes a needle valve disposed at the fuel nozzle inlet to variably control flow of fuel through the fuel nozzle inlet, and a needle valve transmission coupled between the throttle shaft and the needle valve to convert rotation of the throttle shaft to translation of the needle valve to adjust an amount of fuel supply.

According to an additional implementation, a carburetor includes a main body defining a bore extending along an axis, a throttle shaft carried by the main body, and a fuel nozzle carried by the main body. The carburetor also includes a needle valve operatively coupled to the fuel nozzle to variably control flow of fuel through the fuel nozzle, and a needle valve transmission coupled between the throttle shaft and the needle valve to convert rotation of the throttle shaft to translation of the needle valve. The transmission includes a cam coupled to the throttle shaft and having a cam surface that at least partially defines a variable air-fuel ratio supplied by the carburetor.

According to a further implementation, a sliding throttle valve carburetor includes a carburetor main body defining an intake bore, a valve member moveable in a direction of a diameter of the intake bore to increase and decrease an open area of the intake bore, and a venturi disposed in the intake bore and having a flow passage narrower than the intake bore. The carburetor also includes a fuel discharge port that opens into the flow passage of the venturi, wherein the valve member is integrally provided with a wall portion such that the wall portion moves with the valve member to open and close openings of the venturi, where the wall portion is disposed so as to move in slidable contact with end surfaces of the venturi defining the openings.

At least some of the objects, features and advantages that may be achieved by at least certain embodiments of the invention include providing a variable venturi carburetor that is less susceptible to deterioration of mileage and exhaust performance after an extended period of use, provides highly accurate fuel supply adjustment with a simple structure, improves fuel vaporization, fuel consumption efficiency, and exhaust characteristics, eliminates inadvertent fluctuation in a fuel flow rate through a jet needle structure, improves precision in fuel flow rate adjustment, allows easy adjustment of the fuel flow rate even after assembly of the apparatus, and is of relatively simple design, economical manufacture and assembly, rugged, durable, reliable, and in service has a long useful life.

Of course, other objects, features and advantages will be apparent in view of this disclosure to those skilled in the art. Various other carburetors embodying the invention may achieve more or less than the noted objects, features or advantages.

### BRIEF DESCRIPTION OF THE DRAWINGS

These and other objects, features and advantages will be apparent from the following detailed description of exemplary embodiments and best mode, appended claims, and accompanying drawings in which:

FIG. 1A is a side elevational view of an exemplary form of a sliding throttle valve carburetor;

FIG. 1B is a side cross-sectional view of the sliding throttle valve carburetor of FIG. 1A;

FIG. 2 is a cross-sectional view taken along line II-II in FIG. 1B;

FIG. 3 is a perspective view showing a valve member and a variable fuel jet structure;

FIG. 4 is a cross-sectional view showing a cam lever portion and the variable fuel jet structure in a closed state; and

FIG. 5 is a view similar to FIG. 4, but shows the variable fuel jet structure in an open state.

### DETAILED DESCRIPTION OF EXEMPLARY EMBODIMENTS

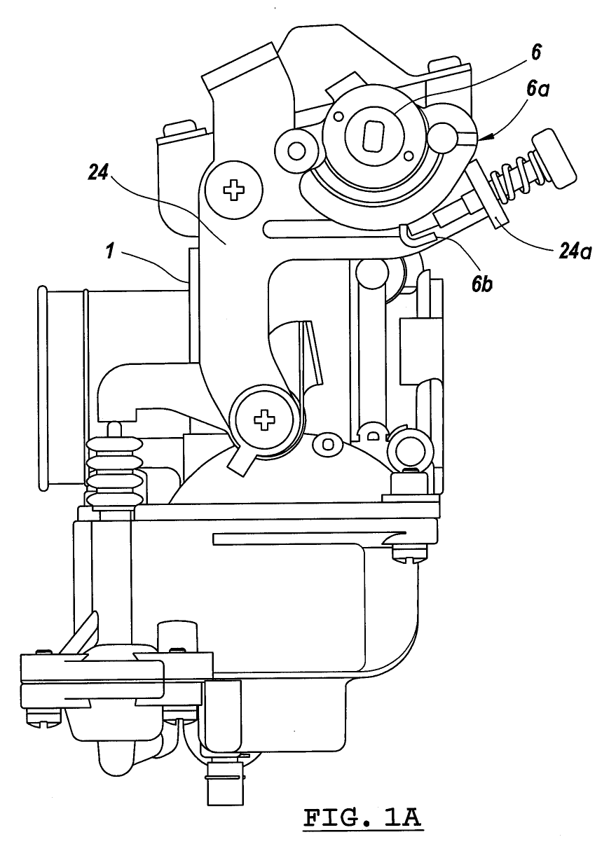

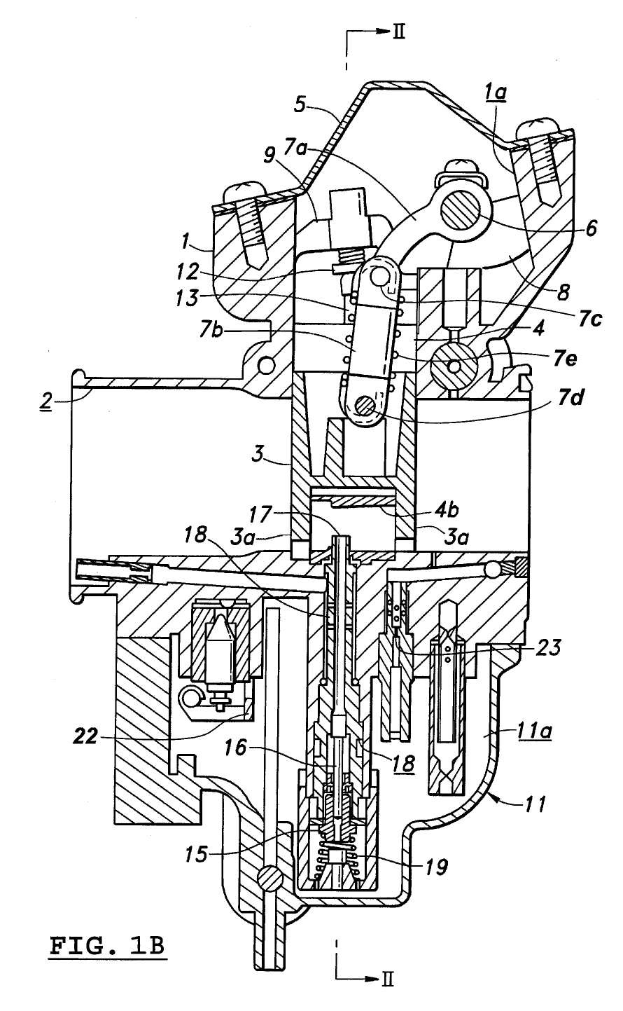

Referring in more detail to the drawings, FIG. 1B illustrates an exemplary carburetor main body 1 formed with a fuel and air mixing passage or intake bore 2 extending therethrough in a horizontal direction of FIG. 1B. A valve member 3 is translatably disposed transversely across an intermediate part of the intake bore 2 to constitute a sliding throttle valve.

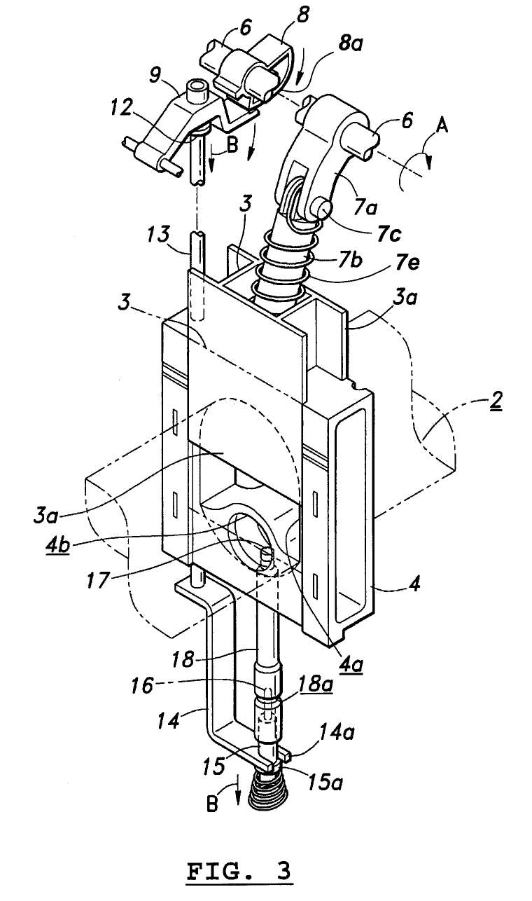

As shown in FIG. 3, the valve member 3 may include a pair of mutually opposed flat plate portions 3a serving as a wall portion, and the flat plate portions 3a are connected to each other by a pair of walls whereby the valve member 3 has a generally H-shaped cross-section with a hollow center. The valve member 3 may instead include a single plate or valve head. The flat plate portions 3a of the valve member 3 are supported by a valve member guide block 4, which may be of generally rectangular shape such that the flat plate portions 3a are moveable in a direction along a principal surface of the flat plate portions 3a.

The valve member guide block 4 is disposed so as to cross the intake bore 2 in a vertical direction, and is formed with a main intake passage 4a and a venturi 4b, each of which extends through the guide block 4 in an axial direction along the intake bore 2. The main intake passage 4a and the venturi 4b are opened and closed with respect to the intake bore 2 by movement of the valve member 3. In FIG. 3, the valve member 3 is shown in a half-opened state. In a fully-closed state, the main intake passage 4a is fully closed but the venturi 4b is kept open with such an open area that just allows an amount of air required for engine idling to flow therethrough. The venturi 4b may be of any suitable shape. For example, the venturi 4b may include a parabolic shaped passage or a substantially cylindrical or constant diameter passage that communicates at each end with the larger bore 2.

In the illustrated embodiment, the valve member 3 assumes a generally H-shaped cross-section including the pair of flat plate portions 3a for opening and closing openings at both ends of the venturi 4b, but the shape of the portions of the valve member 3 for opening and closing the openings of the venturi 4b is not limited to the flat plate shape and may assume, for example, a generally circular outer profile in a plan view when viewed in a direction of opening and closing movement of the valve member 3. In the case that the valve member 3 has a circular outer profile, the valve member supporting portion of the valve member guide block 4 can be formed as a circular hole, and this can make the manufacture of the valve member guide block 4 easier.

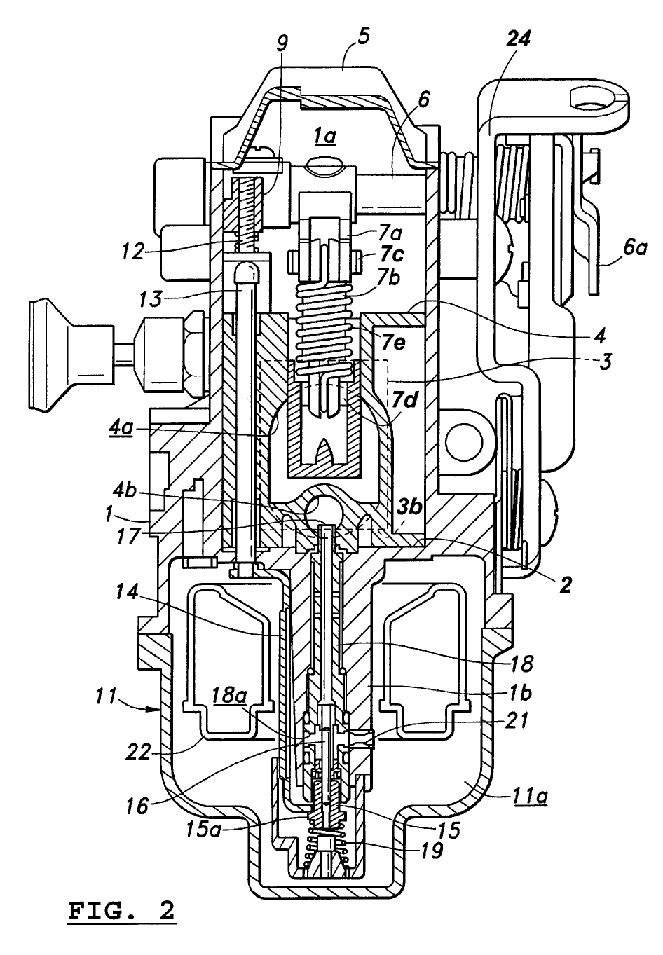

Referring to FIGS. 1B and 2, in an upper part of the carburetor main body 1 a recess 1a opens in an upward direction and a cover 5 covers an opening surface of the recess 1a. The recess 1a and the cover 5 define a space therebetween and this space is adapted to receive the valve member 3 in its valve open state. The space also accommodates a valve member transmission or valve open/close operation means, which moves the valve member 3 and is described below.

A throttle shaft 6 is provided in the recess 1a so as to extend in a direction perpendicular to the axis of the intake bore 2 and across the space within the recess 1a. Fixed to an end portion of the throttle shaft 6 that protrudes out of the carburetor main body 1 (a right end portion in FIG. 2) is a throttle arm 6a that is connected to an external throttle device via a cable (not shown) so that operation of the throttle causes the throttle shaft 6 to rotate around its axis. As shown in FIG. 3, an arrow A indicates a direction of rotation for opening the valve member 3.

Referring to FIGS. 1B and 2, one end of an arm 7a extends in a radial direction of the throttle shaft 6 and is fixedly connected to the throttle shaft 6, and the other end of the arm 7a is connected to the valve member 3 via a connecting rod 7b. The connecting rod 7b is coupled to the arm 7a via a first pin 7c and to the valve member 3 by a second pin 7d, wherein a slack adjusting device 7e, such as a coiled tension spring, is coupled between the pins 7c, 7d to take up slack between the arm 7a and the valve member 3. Thus, when the throttle shaft 6 is rotated by a throttle operation, the arm 7a rotates together and the movement of the arm 7a is transmitted to the valve member 3 via the connecting rod 7b, whereby the valve member 3 at least partially opens/closes the bore 2.

Although those of ordinary skill in the art will appreciate that there are many ways to adjust a throttle shaft for idle operation, FIG. 1A shows one exemplary idle speed adjustment arrangement. A mounting bracket 24 may be carried by the carburetor main body 1 and may include a flange 24a to which is mounted an idle adjuster 25 such as a screw and spring as shown. The idle adjuster 25 cooperates with a flange 6b of the throttle arm 6a, such that when the idle adjuster 25 is adjusted the throttle arm 6a and throttle shaft 6 rotate in the direction of adjustment. Accordingly, an idle position of the valve member 3 may be set by adjusting the idle adjuster 25. FIG. 1B illustrates an exemplary idle position of the valve member 3.

Referring to FIGS. 1B and 2, a fuel supply means such as a fuel bowl or fuel supply adjuster 11 is coupled to a part of the carburetor main body 1 opposite of the recess 1a across the intake bore 2. The fuel supply adjuster 11 at least partially defines a fuel reservoir 11a to hold fuel. In the illustrated embodiment, the fuel supply adjuster 11 is of a float type in which a float 22 is received in the fuel reservoir 11a. The fuel reservoir 11a is in flow communication with a fuel tank (not shown) so that an appropriate amount of fuel is supplied to the fuel reservoir 11a in response to a position change of the float 22 corresponding to a change in a surface level of the fuel contained in the fuel reservoir 11a.

Referring to FIGS. 3 through 5, a fuel supply adjuster may be provided for adjusting the rate at which fuel is supplied from the carburetor according to movement of the valve member 3 caused by operation of the throttle valve member transmission. In this implementation, a fan-shaped cam 8 is secured to the throttle shaft 6 such that the cam 8 rotates with the throttle shaft 6, and a pivot lever or cam lever 9 is pivotably supported on a pin carried by a wall surface that opposes the throttle shaft 6 within the recess 1a. A cam surface of the cam 8 is adapted to abut a free end portion of the cam lever 9 at a location spaced from the pivoted end of the lever 9, and the lever 9 is spring-biased in such a direction that the free end portion of the lever 9 is pressed against the cam surface 8a. The cam surface 8a is designed such that its radius with respect to the throttle shaft 6 increases with a rotation angle toward the fully open position. The cam surface 8a may be shaped to at least partially define a variable air-fuel ratio supplied by the carburetor. In other words, the air-fuel ratio of the carburetor may be a function of the shape of the cam surface 8a. The free end of the lever 9 may carry a cam contact member 9a for reliable contact with the cam surface 8a and less sensitivity to manufacturing tolerances compared to contact of the cam 8 and lever 9 alone. For example, the cam contact member 9a may be a steel pin, which may be press fit into a corresponding aluminum portion of the lever 9. Also, an adjustment member or mechanism such as a screw 12 is coupled to an intermediate part of the extension of the cam lever 9, which serves as an intermediate moving part of the cam lever 9.

A fuel adjustment rod 13 extends between the recess 1a and the fuel reservoir 11a of the fuel supply adjuster 11, and an end of the adjustment screw 12 abuts an end of the fuel adjustment rod 13 in the recess 1a. The fuel adjustment rod 13 extends through a portion of the valve guide block 4 beside the main intake passage 4a, and is supported so as to be moveable in a direction of its extension. An end of the fuel adjustment rod 13 on a side of the fuel reservoir 11a is connected to one end of an extension member 14, the other end of which is formed with a fork-shaped engagement portion 14a to engage an upper surface of an outer flange 15a of a needle support member 15. Thus, the fuel adjustment rod 13 and the extension member 14 constitute an open/close operation amount transmitting mechanism.

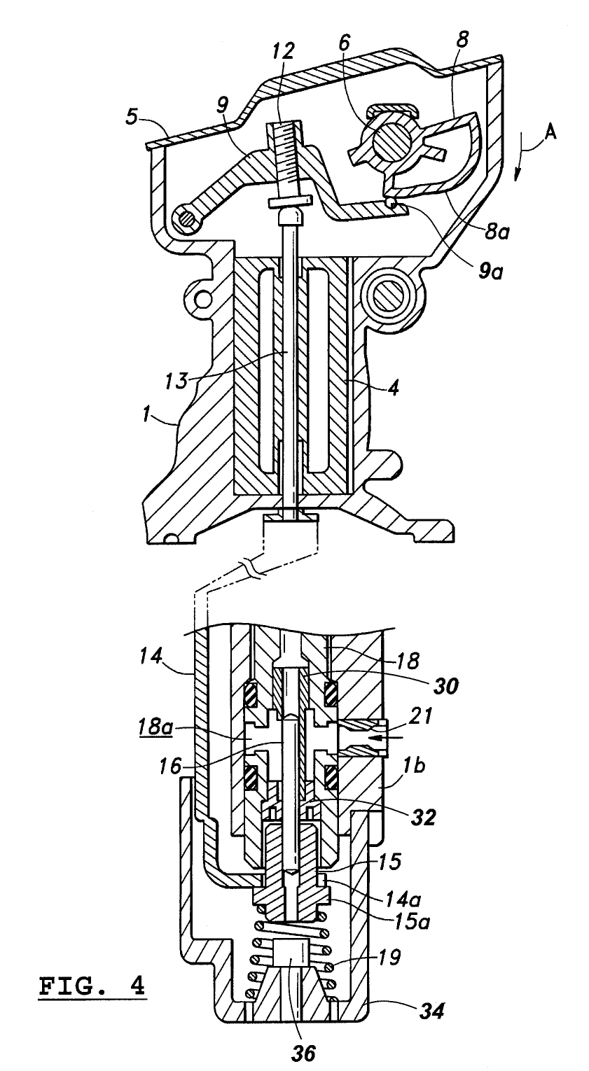

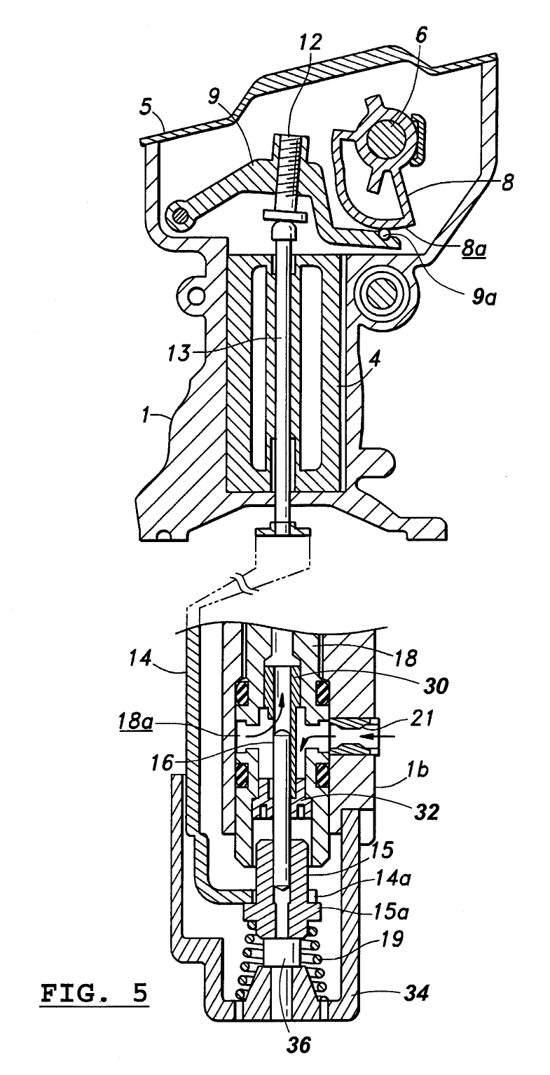

The needle support member 15 fixedly holds a base end of a needle valve or member 16. The needle member 16 may have a substantially constant diameter over substantially its entire length. A fuel nozzle outlet or main fuel discharge port 17 of a fuel nozzle or tubular member 18 opens into the venturi 4b. The needle support member 15 and needle member 16 are inserted into the tubular member 18 and are supported in such a manner that the needle support member 15 and needle member 16 can move relative to the tubular member 18. The needle member 16 is disposed at a fuel nozzle inlet, which may be substantially opposite of the fuel discharge port 17, to control flow of fuel through the fuel nozzle inlet. A fuel nozzle post or pillar-like boss portion 1b (FIGS. 4 and 5) extends from an undersurface of the carburetor main body 1 into the fuel reservoir 11a, and the tubular member 18 is concentrically received in the pillar-shaped boss portion 1b.

The needle support member 15 is spring-biased, such as by a cone spring 19 interposed between the bottom of the fuel reservoir 11a (FIG. 2) and the needle support member 15, in a direction of insertion into the tubular member 18. Thus, the cone spring 19 may also spring-bias the fuel adjustment rod 13 against the adjustment screw 12 at all times so that the fuel adjustment rod 13 can move to follow the movements of the adjustment screw 12 caused by pivoting movements of the cam lever 9. In the fully closed state of the throttle valve 3, the cam lever 9 abuts a part of the cam surface 8a having the smallest radius with respect to the throttle shaft 6, as shown in FIG. 4. Because the needle member 16 is spring-biased in a direction of insertion into the tubular member 18 and the needle member 16 is moved against the spring force, the position of the needle member 16 can be prevented from fluctuating, and thus it is possible to achieve highly accurate fuel supply adjustment with a simple structure.

When the throttle is operated toward the fully-open state, the fuel adjustment rod 13 and the extension member 14 move in a direction as indicated by an arrow B in FIG. 3, and the fork-shaped engagement portion 14a pushes the outer flange 15a in this direction of movement. Therefore, when the throttle is operated toward the fully-open state as shown in FIG. 5, the needle support member 15 is moved to be drawn outwardly from the tubular member 18.

Referring to FIGS. 4 and 5, an exemplary variable fuel jet structure will be described. A portion of the cylindrical wall of the tubular member 18 that overlaps with the upper end portion of the needle member 16 is formed with a passage or annular groove 18a such that fuel flow through the annular groove 18a can be effectively blocked depending on the position of the needle member 16. In the illustrated embodiment, the annular groove 18a is in flow communication with the fuel reservoir 11a via a jet 21 provided in a cylindrical wall of the pillar-like boss portion 1b. Also, a needle valve seat 30 may be inserted into the inlet end of the tubular member 18, and a seat support 32 may also be inserted into the inlet end of the tubular member 18 to support a free end of the seat 30. The seat 30 may be semi-cylindrical, as shown in FIGS. 4 and 5 to force fuel incoming through the jet 21 to flow around the seat 30 within the groove 18a before it flows past the needle member 16 as shown in FIG. 5. In such a structure, depending on the position of the needle member 16, an appropriate amount of fuel in the fuel reservoir 11a can be ejected from the main fuel discharge port 17 via the tubular member 18.

As also shown in FIGS. 4 and 5, a nozzle cap 34 may be coupled in any suitable manner to a free end of the nozzle post 1b. The nozzle cap 34 may carry a stopper 34 that may be used to limit travel of the needle member 16 by way of the needle support member 15, as best shown in FIG. 5.

Further, as shown in FIG. 1B, a low speed fuel jet 23 is provided between the fuel reservoir 11a and the carburetor main body 1. In an idling state of the throttle valve (i.e., the valve member 3 is at the fully-closed position), the fuel supply to the input bore 2 is conducted via the low speed fuel jet 23.

Next, exemplary operation of the carburetor is explained. In the idling state of the carburetor, the fuel supply is conducted through the low speed fuel jet 23 as shown in FIG. 1B. In this state, and as shown in FIG. 2, air flows through one or more gaps between the intake bore 2 and the valve member 3. The air flow rate can be set as a function of distance between a lower end 3b of the flat plate portion 3a of the valve member 3 and the opposing inner surface of the intake bore 2.

The positional relationship among the component parts constituting the variable fuel jet in the idling state is shown in FIG. 4. Specifically, the extended end of the cam lever 9 abuts a portion of the cam surface 8a that has the smallest radius (distance) from the center of the throttle shaft 6, and the fuel adjustment rod 13, the extension member 14 and the needle support member 15 are brought to their highest positions by the spring force of the cone spring 19. Thus, the needle member 16, which is fixed to the needle support member 15 in any suitable manner, is pushed up to the closed position to fully block the flow of fuel through the fuel nozzle inlet.

In a low speed or small opening state where the throttle has been operated in the direction indicated by the arrow A in FIG. 4 so that the valve member 3 is slightly lifted to a position shown by two-dot chain lines in FIG. 3, the valve member 3 exposes only the openings of the venturi 4b. Therefore, the air is allowed to flow only through the venturi 4b and this can create a strong negative pressure acting upon the main fuel discharge port 17. This can result in favorably vaporized fuel discharged into the intake bore 2 via the venturi 4b and, thus, contributes to improving the fuel consumption efficiency and exhaust characteristics.

As mentioned above, in the conventional sliding throttle valve carburetor, a fuel metering needle member, which is called a jet needle, is inserted into the main fuel discharge port that opens into the intake bore, and the needle member is formed with a converging end portion so as to be able to vary an amount of gap between the needle member and the main fuel discharge port to thereby control the amount of fuel discharge. However, in such a structure, the needle member and the main fuel discharge port can contact each other due to engine vibrations or the like, and this can cause abrasion in the needle member and thus result in unfavorable change in the fuel metering characteristics. The change in the amount of fuel discharge can affect the exhaust gas composition and lead to deteriorated exhaust gas characteristics.

With the presently disclosed exemplary embodiments, there may be no jet needle structure (or needle valve) with a needle member having a converging end portion and moved into and out of the main fuel discharge port 17 that opens into the intake bore 2 and, therefore, the above described problem in the conventional carburetor does not arise. Further, in order to cope with problems such as delay in fuel discharge or poor fuel atomization that could be caused due to the absence of the jet needle structure, the carburetor of the exemplary embodiments disclosed herein is equipped with the venturi 4b as described above to create a large negative pressure acting upon the main fuel discharge port 17. Specifically, the valve member 3 is adapted to be able to open and close openings at both ends of the venturi 4b in the direction of air flow by slidingly moving the flat-plate portions 3a along the end surfaces of the venturi 4b defining the openings. Such a structure can eliminate an expansion space that would otherwise reduce the flow rate inside the venturi, and thus contribute to creating larger negative pressure acting upon the main fuel discharge port 17.

Further, as to the fuel metering, which could be performed in the conventional embodiment by the jet needle structure constituted by the main fuel discharge port 17 and the needle member inserted therein, the fuel metering is achieved by the tubular member 18 that is in flow communication with the main fuel discharge port 17 and the needle member 16 is inserted into the tubular member 18 from an end on the side of the fuel supply adjuster 11 (i.e., from an end away from the main fuel discharge port 17). The needle member 16 can be reciprocally moved along the tubular member 18 to control the amount of fuel that is supplied from the fuel reservoir II a to the main fuel discharge port 17 via the tubular member 18 with a comparable precision as that of the conventional jet needle structure.

Further, it is now possible to reduce or eliminate inadvertent fluctuation in the fuel flow rate in the jet needle structure that can be attributed to conducting fuel metering at a portion where the air flows at a high speed. Control of fuel supply to the fuel discharge port 17 is achieved by controlling the position of the needle member 16 inserted into the tubular member 18 to vary fuel flow through the fuel nozzle inlet. Thus, the fuel metering can be achieved by using the needle member 16 having a substantially equal diameter substantially over its length, and there is no need to use the conventional jet needle structure. This can eliminate a jet needle structure that may suffer abrasion due to engine oscillations or the like.

In other words, the needle member 16 does not need to have a converging end portion to be inserted into and moved out of the tubular member 18, and can have a same diameter to its tip end as described above. This can prevent collision between the needle member 16 and the tubular member 18 with a substantial space therebetween when applied with engine oscillations and the like. Thus, the carburetor disclosed herein is less likely to suffer deterioration with time unlike the conventional jet needle structure, and hence it is possible not only to improve the fuel consumption efficiency and the exhaust characteristics but maintain the favorable exhaust characteristics without deterioration with time. Nonetheless, another implementation could include a conventionally tapered needle member 16 if desired.

Further, in the fuel metering structure as presently disclosed, the free end of the extension of the cam lever 9 that is away from the pivoted end is adapted to slidably contact with the cam 8, and an intermediate portion of the cam lever 9 is adapted to act upon the fuel adjustment rod 13 via the adjustment screw 12. Therefore, an amount of movement of the fuel adjustment rod 13 is smaller than an amount of corresponding movement of the free end of the cam lever 9. Therefore, the adjustment mechanism is less affected by manufacturing or assembly errors regarding the component parts constituting the valve operation transmitting mechanism. This can improve the accuracy of fuel adjustment effected by the adjustment mechanism and/or the accuracy of position control of the needle member to which the amount of operation of the operating means is transmitted via the adjustment mechanism, even in the case where an amount of fuel discharge is particularly sensitive to a change in a valve opening area. In the above structure, the fuel increase/decrease characteristics can be freely altered by changing the cam shape, and therefore, the design change in accordance with the engine characteristics can be achieved easily.

The adjustment screw 12 transmitting the movement of the cam lever 9 to the fuel adjustment rod 13 is placed in the recess 1a. Thus, just by detaching the cover 5, one can access the adjustment screw 12 and rotate it to adjust the relative position of the fuel adjustment rod 13 or the needle member 16 with respect to the valve member 3. This allows an easy adjustment of fuel flow rate even after assembly of the apparatus.

It should be also noted that the fuel adjustment rod 13 is disposed inside of the carburetor main body 1. This eliminates a need for an additional protective structure against an abrupt external force as well as an additional dustproof structure, which would be required and complicate the structure if the fuel adjustment rod 13 were provided outside of the carburetor main body 1. Nonetheless, the rod 13 may be disposed partially or completely outside of the main body 1, if desired.

In the illustrated embodiment, the adjustment screws 12 and the fuel adjustment rod 13 abut each other. The spring-biasing force acting upon the needle support member 15 also pushes the fuel adjustment rod 13 and the extension member 14, which engages the needle support member 15, against the adjustment screw 12. Therefore, though the fuel adjustment rod 13 is not fixedly connected to the adjustment screw 12, the fuel adjustment rod 13 can follow the movements of the adjustment screw 12 in the direction of spring-biasing force without rattling. Further, the total length of the fuel adjustment rod 13 and the extension member 14 can be adjusted by using an insertion bush, and it is possible to press-fit an insertion bush to the fuel adjustment rod 13 by using a jig, for example, to thereby improve the assembly accuracy.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

What is claimed is:

1. A carburetor, comprising:
a main body defining a bore extending along an axis;
a main passage defined within the bore;
a venturi defined within the bore;
a fuel nozzle carried by the main body and including a fuel nozzle outlet in fluid communication with the venturi; and
a valve member translatable with respect to the axis of the bore of the main body to control an open area of the bore, such that in a closed state, the valve member closes the main passage but maintains the venturi at least partially open to allow an amount of air for engine idling to flow therethrough.

2. The carburetor set forth in claim 1, wherein the valve member includes a wall portion disposed so as to move in slidable contact with end surfaces of the venturi defining openings of the venturi.

3. The carburetor set forth in claim 2, wherein the valve member includes a pair of walls connecting the wall portion such that the valve member has a generally H-shaped cross-section with a central hollow portion.

4. The carburetor set forth in claim 1, further comprising a valve member guide block carried by the main body across the bore to support the valve member and defining the main passage and the venturi.

5. The carburetor set forth in claim 1, further comprising a valve member transmission, including:
a shaft extending through the main body;
a throttle lever coupled to the shaft external of the main body;
an arm coupled to the shaft; and
a connecting rod coupled to the arm and to the valve member, wherein throttle operation moves the throttle lever to rotate the shaft, which rotates the arm and moves the valve member via the connecting rod.

6. The carburetor set forth in claim 5, wherein the valve member transmission further includes a slack adjusting device coupled between the valve member and the arm.

7. The carburetor set forth in claim 6, wherein the slack adjusting device is a coiled tension spring coupled between pins, which couple the connecting rod to the arm and to the valve member.

8. The carburetor set forth in claim 5, further comprising an idle adjustment device carried by the main body and coupled to the throttle lever to adjust an idle position of the valve member.

9. The carburetor set forth in claim 1, further comprising:
a throttle shaft carried by the main body;
a fuel bowl carried by the main body and at least partially defining a fuel reservoir;
a needle valve disposed at a fuel nozzle inlet of the fuel nozzle to variably control flow of fuel through the fuel nozzle inlet; and
a needle valve transmission for converting rotation of the throttle shaft to translation of the needle valve to adjust an amount of fuel supply according to movement of the valve member.

10. The carburetor set forth in claim 9, wherein the needle valve transmission includes:
a cam coupled to the throttle shaft;
a needle support member carrying the needle valve;
a linkage operatively coupled between the cam and the needle valve and extending through the carburetor, wherein the linkage includes a rod extending through the main body between the recess and the fuel reservoir, and an extension member connected between the rod and the needle support member; and
a cam lever pivotally carried by the main body and biased in such a direction so as to maintain contact with the cam and with the linkage.

11. The carburetor set forth in claim 10 wherein a free end of the cam lever slidably contacts the cam and an intermediate portion of the cam lever acts on the rod.

12. The carburetor set forth in claim 11, further comprising an adjustment member coupled to the cam lever for contact with the linkage to allow for adjustment of fuel flow rate after assembly of the carburetor.

13. The carburetor set forth in claim 10, further comprising a spring to bias the needle valve toward a closed position and to bias the linkage of against the adjustment member.

14. A carburetor, comprising:
a main body defining a bore extending along an axis;
a main passage defined within the bore;
a venturi defined within the bore;
a throttle shaft carried by the main body;
a fuel bowl carried by the main body and defining a fuel reservoir;
a fuel nozzle carried by the main body, and including a fuel nozzle inlet in fluid communication with the fuel reservoir and a fuel nozzle outlet in fluid communication with the venturi;
a needle valve disposed at the fuel nozzle inlet to variably control flow of fuel through the fuel nozzle inlet; and
a needle valve transmission coupled between the throttle shaft and the needle valve to convert rotation of the throttle shaft to translation of the needle valve.

15. The carburetor set forth in claim 14, further comprising:
a valve member translatable with respect to the axis of the bore of the main body to control an open area of the bore; and
a valve member transmission coupled between the throttle shaft and the valve member to actuate the valve member.

16. The carburetor set forth in claim 15 wherein the main body includes a fuel nozzle post in fluid communication with the fuel reservoir and carrying the fuel nozzle.

17. The carburetor set forth in claim 16, further comprising a nozzle cap coupled to the nozzle post and carrying a stopper to limit travel of the needle member.

18. The carburetor set forth in claim 14, wherein the needle valve is biased toward a closed position.

19. The carburetor set forth in claim 18, further comprising a conical compression spring interposed between the needle valve and the fuel bowl.

20. The carburetor set forth in claim 14, wherein the needle valve transmission includes:
a cam coupled to the throttle shaft; and
a linkage operatively coupled to the cam and to the needle valve and extending through the carburetor.

21. The carburetor set forth in claim 20, wherein the cam includes a cam surface having a radius that increases with a rotation angle toward a fully open position of the valve member.

22. The carburetor set forth in claim 20, wherein the cam includes a cam surface shaped to at least partially define a variable air-fuel ratio supplied by the carburetor.

23. The carburetor set forth in claim 20, wherein the needle valve transmission further includes:
a cam lever pivotally carried by the main body and biased in such a direction to maintain contact with the cam and with the linkage.

24. The carburetor set forth in claim 23, wherein the needle valve transmission further includes:
a needle support member carrying the needle valve; and
wherein the linkage includes:
a rod extending through the main body between the recess and the fuel reservoir; and
an extension member connected between the rod and the needle support member.

25. The carburetor set forth in claim 24 wherein a free end of the cam lever slidably contacts the cam and an intermediate portion of the cam lever acts on the rod.

26. The carburetor set forth in claim 25, wherein the free end of the cam lever carries a cam contact member for contact with the cam.

27. The carburetor set forth in claim 26, wherein the cam contact member is a pin pressed into the cam lever.

28. The carburetor set forth in claim 23, further comprising an adjustment member coupled to the cam lever for contact with the linkage to allow for easy adjustment of fuel flow rate after assembly of the carburetor.

29. The carburetor set forth in claim 20, further comprising a spring to bias the needle valve toward a closed position and to bias the linkage against the adjustment member.

30. The carburetor set forth in claim 14 wherein a portion of the fuel nozzle is formed with a groove that is opened and closed to fluid flow therethrough depending on the translational position of the needle valve within the fuel nozzle.

31. The carburetor set forth in claim 30 wherein the nozzle post includes a fuel jet in communication with the groove of the fuel nozzle, wherein the groove and the fuel jet at least partially define the fuel inlet.

32. The carburetor set forth in claim 31, further comprising:
a needle valve seat carried at the inlet end of the fuel nozzle and being semi-cylindrical to force fuel incoming through the jet to flow around the seat within the groove of the fuel nozzle before the fuel flows past the needle member.

33. The carburetor set forth in claim 32, further comprising a seat support carried at the inlet end of the fuel nozzle to support a free end of the needle valve seat.

34. The carburetor set forth in claim 14 wherein the needle valve has a substantially constant diameter from one end to another.

35. A carburetor, comprising:
a main body defining a bore extending along an axis;
a throttle shaft carried by the main body;
a fuel nozzle carried by the main body;
a needle valve operatively coupled to the fuel nozzle to variably control flow of fuel through the fuel nozzle; and
a needle valve transmission coupled between the throttle shaft and the needle valve to convert rotation of the throttle shaft to translation of the needle valve, wherein the transmission includes a cam coupled to the throttle shaft and having a cam surface that at least partially defines a variable air-fuel ratio supplied by the carburetor.

36. The carburetor set forth in claim 35, further comprising:
a valve member translatable with respect to the axis of the bore of the main body to control an open area of the bore; and
a valve member transmission coupled between the throttle shaft and the valve member to actuate the valve member;
wherein the cam surface has a radius that increases with a rotation angle toward a fully open position of the valve member.

37. A sliding throttle valve carburetor, comprising:
a carburetor main body defining an intake bore;
a valve member moveable in a direction of a diameter of the intake bore to increase and decrease an open area of the intake bore;
a venturi disposed in the intake bore and having a flow passage narrower than the intake bore; and
a fuel discharge port that opens into the flow passage of the venturi;
wherein the valve member is integrally provided with a wall portion such that the wall portion moves with the valve member to open and close openings of the venturi, and wherein the wall portion is disposed so as to move in slidable contact with end surfaces of the venturi defining the openings.

38. The sliding throttle valve carburetor according to claim 37, further comprising:
a valve open/close operation means to be operated from outside the carburetor for moving the valve member;
a fuel supply means attached to the carburetor main body to supply fuel to the fuel discharge port; and
a fuel supply adjuster for adjusting an amount of fuel supply according to a movement of the valve member caused by an operation of the valve open/close operation means, wherein the fuel supply adjuster comprises:
a fuel reservoir;
a tubular member in fluid communication with the fuel discharge port and having a cylindrical wall provided with a passage open to the fuel reservoir;
a needle member moveably inserted into the tubular member such that the needle member can open and close the fuel nozzle inlet depending on a position of the needle member inside the tubular member; and
an open/close operation amount transmitting mechanism for transmitting an amount of operation of the valve open/close operation means to the needle member.

39. The sliding throttle valve carburetor according to claim 38, wherein the needle member is spring-biased in a direction of insertion into the tubular member, and in response to a movement of the valve member in a valve opening direction caused by the operation of the valve open/close operation means, the open/close operation amount transmitting mechanism causes the needle member to move in a pull-out direction with respect to the tubular member against the spring force.

40. The sliding throttle valve carburetor according to claim 39, further comprising an adjustment mechanism for adjusting a position of the open/close operation amount transmitting mechanism with respect to the amount of operation of the valve open/close operation means.

41. The sliding throttle valve carburetor according to claim 40, wherein the open/close operation amount transmitting mechanism comprises a cam lever adapted to undergo a pivoting movement in response to the external operation, and wherein the adjustment mechanism is provided at an intermediate moving portion of the cam lever between a pivot point of the cam lever and a part of the cam lever to which the external operation is transmitted.
